(19) United States
(12) Patent Application Publication
(10) Pub. No.: US 2007/0136077 A1
(43) Pub. Date: Jun. 14, 2007

(54) Asset inspection apparatus and methods

(75) Inventors: Benjamin Essig Hammond, Visalia, CA (US); David T. Lorenzen, Irvine, CA (US); Philip Randolph Hammond, Visalia, CA (US)

Correspondence Address: FISH & ASSOCIATES, PC;ROBERT D. FISH, 2603 Main Street, Suite 1050, Irvine, CA, 92614-6232, US

(73) Assignee: Tetra Property Management, LLC

(21) Appl. No.: 11/289,980

(22) Filed: Nov. 29, 2005

(51) Int. Cl. G06Q 99/00

(52) U.S. Cl. 705/1

(57) ABSTRACT

A method of conducting asset inspections is presented. Data models describe characteristics of one or more assets from which a description of actual assets are built. Multiple customized inspection surveys directed toward the assets can be created from a single data model. Inspection surveys identify inspection point where inspection data and validation information is collected. Validation information is used to validate an inspection has been conducted or conducted properly. Furthermore asset histories can be created for data mining trends or correlations of the asset with respect to other data.

### FIELD OF THE INVENTION

The field of the invention relates to methods of conducting inspections.

### BACKGROUND OF THE INVENTION

An asset represents a real world, physical object that requires inspection, whether the inspection is required by the state, is a regularly schedule procedure, is for preventive maintenance, or a general procedure. For assets used by the public, a significant number of inspections might be required to ensure the asset is safe, insurable, or for other reasons. Therefore, considerable costs, energy, and time have been spent to ensure inspections are:

Actually conducted without falsifying inspection data

Done properly according to proper procedures

Valid

Unfortunately, even though asset owners, inspectors, or agencies employ considerable amount of effort to ensure the validity of inspections, property owners or insurance companies still find themselves at the center of costly litigations. For property owners who own multiple properties, the litigation risk is worse due the increased probability of being at the center of litigation or due to managing multiple agency inspection formats (state, county, fire, safety, USDA, ADA, HUD REAC, or others) for each property. For example, in some cases it is common for a tenant in an affordable housing residential property to make claims against the property owner knowing that owner's insurance company would rather settle than litigate a potential problem. Unfortunately, insurance companies find it more cost effective to settle than to litigate, which still costs the insurance company money and increases the premiums paid by the property owner. One reason an insurance company takes the settlement path is because inspection data might not appear to be valid in the eyes of a jury.

There remains a need for methods of conducting an inspection that address a property owner's needs for a central, cohesive strategy to build various types of inspections of their assets, to track inspection data taken at inspection points at various times, to validate inspection data, or to correlate inspection data with historical inspection data. For example, an owner of affordable residential housing has to conduct multiple inspections for agencies who are involved in a housing project. A single property in California could have inspections required by the Department of Housing and Urban Development (HUD), California Housing Finance Agency (CalHFA), California Tax Credit Allocation Committee (CTCAC), lenders, California agency of Housing and Community Development (HCD), California Energy Commission (Title 24), or other agencies. Furthermore, keeping track of historical information allows insurance companies, aid agencies, or other institutions to correlate asset histories with other relevant agency data.

Related art associated with inspection systems address limited aspects of the needs stated above. For example, U.S. Patent Application No. 2004/0125208 titled “Forensic communication apparatus and method” teaches the use of an apparatus to validate inspection data through obtaining a key from a trusted third party, but does not teach how to build various inspections for an asset from a central, cohesive system. Furthermore, U.S. Pat. No. 5,856,931 titled “Method and system for identifying, organizing, scheduling, executing, analyzing, and documenting detailed inspection activities from specific items in either a time based or on-demand based fashion” teaches an inspection process, but also does not address building various inspections from the central, cohesive system or instantiating an asset survey.

U.S. Pat. No. 6,581,045 title “Asset management system for analyzing the condition of assets and evaluation repair/replication options” teaches the use of an asset management system for inspecting physical or structural assets including roofs. However, it does not address the need for real estate inspections as a whole nor does it address the need for validating the inspection.

The related art references various aspects of inspections or validation information including GPS data or obtaining keys from third parties, they do not address the over arching need for asset wide validation for specific asset surveys that are built from a central, cohesive system.

A more complete solution that would satisfy the needs of property owners, insurance companies, or other institutions that require inspection data would embody the following key concepts:
Ability to create a data model representing the characteristics of an asset and inspection criteria to be used as centralized, cohesive tool for creating inspections
Ability to instantiate an asset survey through the centralized, cohesive tool
Ability to obtain validation information associated with the actual asset survey and to validate an inspection

Although this document primarily references conducting surveys for real estate, it is specifically contemplated the inventive subject matter also applies to other markets including, but not limited to, medial inspections, vehicle inspections, factory inspections, farm inspections, census, disaster recovery, inventories, or other markets where a multiple inspections are required for a single asset. In addition, the subject matter can be advantageously applied to markets where tracking data over long periods of time is of value including child growth patterns, for example.

### SUMMARY OF THE INVENTION

The present invention relates to conducting an inspection of an asset in a manner that provides for changes in the asset over time, validates an inspection has been conducted, or stores historical inspection data for future use. A common data model is built describing characteristics of an asset including targets of an inspection, target attributes, conditions, or general categories that help filter relevant asset data. Once a data model is built, an actual survey is instantiated based on the data model representing an inspection of a specific owned asset. In a preferred embodiment, a data file representing an order of an asset survey resides on a portable inspection device, a PDA, cell phone, or tablet PC for example. An inspector uses the asset survey to guide him through various actual inspection points associated with the survey and collects inspection data at the inspection points through a set of sensors. The sensors collect inspection data and the inspection device stores the inspection data along with the data file. The inspector uses sensors including cameras to take video or image data, microphones for collection audio data, thermometers to take temperatures, or other sensors to collect inspection data relevant to the asset survey. Furthermore, validation information is obtained associated with the asset survey data file, with the inspection data, or with other aspects of the asset survey to provide ability to validate the inspection. In especially preferred embodiments, the validation information comprises information obtained from a trusted third party including a secret, a device used during the collection of inspection data, or previous inspection data.

Glossary

The following terms are used in their broadest sense within this document without express or implied limitations. The following definitions are intended to provide the reader with a clear understanding of the inventive subject matter.

The term “asset” herein means a real world, physical entity to be inspected that comprises one or more instantiated objects. For example, an asset includes a specific apartment building with a number of residential units that require an inspection, a commercial building with a number of store fronts, or an automobile with a number safety points. An asset is not an “object” or “class” in the computer science sense, but rather an instantiation of an object. For example, a “chair” is a class of objects, but an asset would be “that specific chair” along with its parts, attributes, conditions, or other characteristics.

The term “data model” herein means a virtual representation of characteristics that could be associated with an asset. A data model is not a database representing a series of data records, but rather a series of generic characteristics that are linked together. Characteristics include, but are not limited to, concepts of targets, attributes, conditions, or categories. For example, a chair represents a target, the chair's color represents an attribute, the chair's state (i.e. faded, worn, broken) represents a condition, or categories that aid in indicating if a chair should or should not be in an asset survey.

The term “survey” herein means a series of specific inspection points associated with an asset that can be used by an inspector as a guide through an actual inspection process.

The term “validation information” herein means information used to validate an inspection, inspection data, or to validate other aspects of an inspection process. Validation information is not the current inspection data itself, but rather information associated with the data used to ensure the veracity of the inspection data.

The teachings herein may be advantageously employed by asset owners, property owners, companies, governments, or institutions that desire validated inspections. Asset inspection methods can be employed to manage residential properties, commercial properties, vehicles, insurance clients, or other assets where safety or costs are critical.

Various objects, features, aspects, and advantages of the present invention will become more apparent from the following detailed description of the preferred embodiments of the invention, along with the accompanying drawings in which like numerals represent like components.

### BRIEF DESCRIPTION OF THE DRAWINGS

FIG. 1 represents a possible schematic for a data model.

FIG. 2 represents a possible schematic for a specific asset built from a data model.

FIG. 3 represents an instantiation of an asset survey customized to an asset.

FIG. 4A represents a possible schematic of a portable inspection device.

FIG. 4B represents a possible schematic of a validation device.

FIG. 4C represents an example of a PDA inspection device with an embodiment of an inspection receipt.

FIG. 5 represents a schematic of possible steps for conducting an inspection.

FIG. 6A represents a schematic of possible steps for validating an inspection through obtaining a secret.

FIG. 6B represents a schematic of possible steps for validating an inspection through obtaining previous inspection data.

FIG. 6C represents a schematic of possible steps for validating an inspection through obtaining two sets of inspection data.

### DETAILED DESCRIPTION

Although this document references an asset as residential or commercial real estate, it is also contemplated that the subject matter applies to other forms of assets including, but not limited to, automobiles, airplanes, construction sites, or other types of assets that lend themselves to inspection. It is especially contemplated the inventive subject matter is directly applicable to state mandated asset inspections.

Data Model

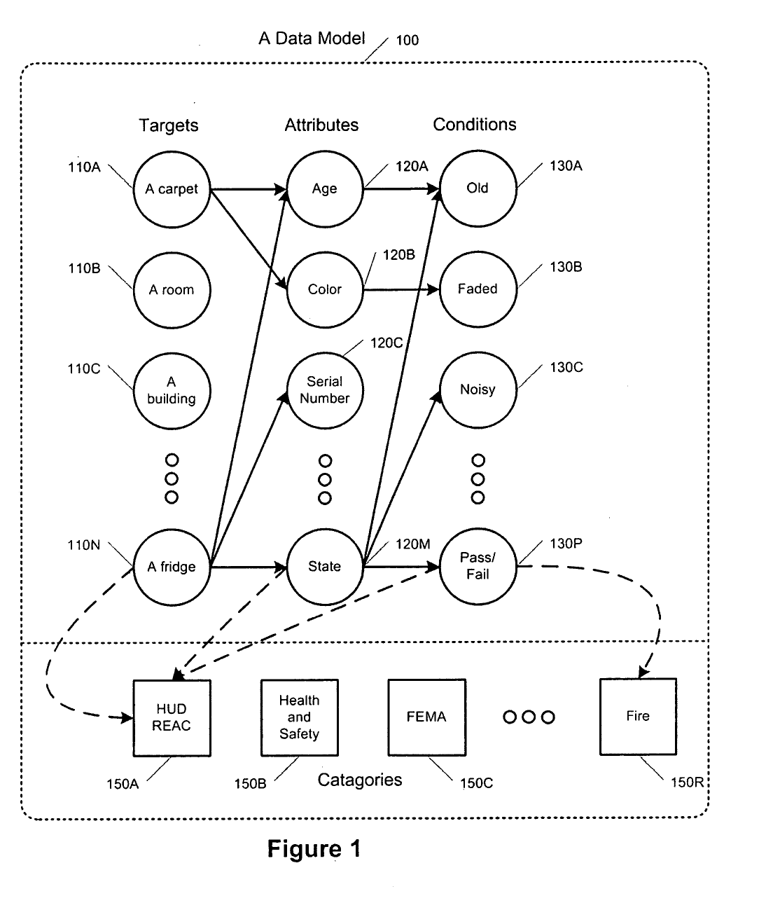

FIG. 1 represents a schematic for a possible data model. An embodiment of data model 100 represents a loose association among desirable characteristics that aid in the definition of an asset and of an asset survey. A real estate asset preferably comprises characteristics including targets, attributes, conditions, or categories. Each of the characteristic elements is able to connect to others of the characteristic elements forming linked associations. The linked associations are then used to form instantiations of objects representing specific real world objects.

Even though each of the characteristics in data model 100 is able to form linked associations, the characteristics are also standalone elements. In a preferred embodiment, data model 100 does not necessarily have to be a database of objects, but rather a collection of individual data structures that exist independently of each other. For example, target 110A represents a data structure with the property of being a “target.” In addition, the data structure for target 110A comprises pointers to data structures with the property of being an “attribute.” In the example show, target 110A points to attribute 120A, an age attribute, and attribute 120B, a color attribute, thereby forming a linked associated between target 110A and attributes 120A and 120B. Linked associations continue to conditions or categories. To continue the example, the data structure for attribute 120A points to condition 130A, an “old” condition value. Categories 150A through 150R can be linked to targets, attributes, or conditions in any manner wherein categories broadly represent filter categories. Consequently, a template for an object to be inspected is formed by the linked associations. One ordinarily skilled in the art of software development will recognized data model 100 could be formed through a number of methods including linked lists, XML data structures, multiple indexed files, or other software programming techniques used to create data structures.

In the preferred embodiment, each data structure comprises a plurality of data members. As mentioned previously a property field identifies the type of characteristic. Contemplated data members include a unique identifier (a GUID for example), fields to be filled in during asset creation, time stamp fields, literals, constants, strings, pointers, or other data members useful in establishing or maintaining the characteristic elements.

As a further example to illustrate how data model 100 can be used, consider target 110N representing refrigerators as an aid in the creation of surveys for inspecting refrigerators. A refrigerator target has a state defined by attribute 120M. The state is represented by condition 130P with a value of “pass/fail,” by condition 130A with a value of “old,” or by condition 130C with a value of “noisy.” Consequently, during an inspection, when an existing refrigerator is inspected, an inspector will select one or more of the condition values to be associated with the refrigerator's state, possibly either old or noisy or both. Furthermore, the refrigerator target and its other associations fall within categories 150A and 150R representing that a refrigerator target is a member of HUD REAC item category or a member of the fire category.

Data model 100 includes a plurality of categories 150A through 150R which broadly represent filter categories to be used when creating an asset survey. It is contemplated categories 150A through 150R identify the broad types of surveys that are expected to be created. Furthermore, each individual of the categories 150A through 150R can link to the other characteristic elements in data model 100. This allows for fast filtering when creating a custom survey for an asset. Contemplated categories comprise those that identify types of inspections associated with real estate including move-in inspections, move out inspections, fire inspections, wiring inspections, or others. Contemplated categories comprise those that identify state mandated inspections, especially for affordable housing.

Data model 100 also includes a plurality of conditions 130A through 130P which broadly indicates possible values that can be associated with each of attributes 120A through 120M. In other words, conditions 130A through 130P represent what is observable about a target. For example, color attribute 120B could have a value of “faded” as indicated by condition 130B. One should appreciate any number of conditions 130A through 130P can link to any attribute. Conditions 130A through 130P are contemplated to include static values or dynamic values. Examples of dynamic values include a string, an integer, a character, or other similar data types that can be recorded during an inspection by an inspector or sensor. A static value represents those values allowed by the conditions set in the data model or other preset values.

Data model 100 further includes a plurality of attributes 120A through 120M which broadly indicates sets of conditions associated with a target to be inspection. Attributes 120A through 120M represent “what” is to be observed about a target during an inspection. For example, age attribute 120A means the age of the target should be noted during the inspection. Possible values of age attribute 120A include the old condition 130A or others not shown in FIG. 1, thereby forming a set of possible condition values. Contemplated sets include a set with a single condition value, a set with more than one condition value where multiple values pertain to the attribute at the same time, a set with more than one condition value where only one value is applicable to the attribute at a time, or other condition sets. An example of a set with a single condition value includes state attribute 120M with pass/fail condition 130P which can only have a single value, pass or fail. An example of a set where multiple values are applicable includes state attribute 120M with conditions 130A and 130C, old and noisy. Both conditions could apply to a state as the same time.

Data model 100 also includes a plurality of targets 110A through 110N which broadly indicates objects that are to be inspected. Targets 110A through 110N are not actual instantiations of a specific object, but rather object definitions. For example, targets 110A through 110N define carpet target 110A, room target 110B, a building target 110C, or other target objects that can be inspected. In a preferred embodiment, targets include a building complex, a building, an apartment, a room, an appliance, a furnishing, or other objects relating to real estate. It is contemplated other markets beyond real estate would have other applicable targets. For example, the automotive industry could have targets including chassis, brakes, axel, wheels, dashboard, or other vehicle related targets.

Table 1 comprises a listing of contemplated characteristics including targets, attributes, conditions, or categories that could be used in a real estate data model. The listings in Table 1 are not intended to be complete, but rather are presented to clarify how characteristics can be employed.

TABLE 1
Table of possible characteristics for a real estate data model.

| Targets | Attributes | Conditions | Categories |
|---|---|---|---|
| Campus | Paint | Faded | HUD REAC |
| Building | Color | Replace | ADA |
| Unit | Lifetime | Pass/Fail | HDC |
| Room | Square Feet | Clean | Cal HFA |
| Door | Infested | Worn | USDA |
| Appliance | Occupancy | Broken | CTCAC |

Although the preferred embodiment of data model 100 comprises characteristics including targets, attributes, conditions, or categories, it is contemplated other characteristics could also apply for alternative markets. For example, in the automotive market an acceptable characteristic could include “parts.”

In a preferred embodiment, one or more software applications direct an individual through the definition of data model 100. A computer readable memory stores data model 100, possibly on a disk drive, RAM, Flash, or other computer readable memory. Once the individual has created the desired characteristics and the links between the characteristic elements, the individual can use a software application to create an asset from data model 100.

Assets

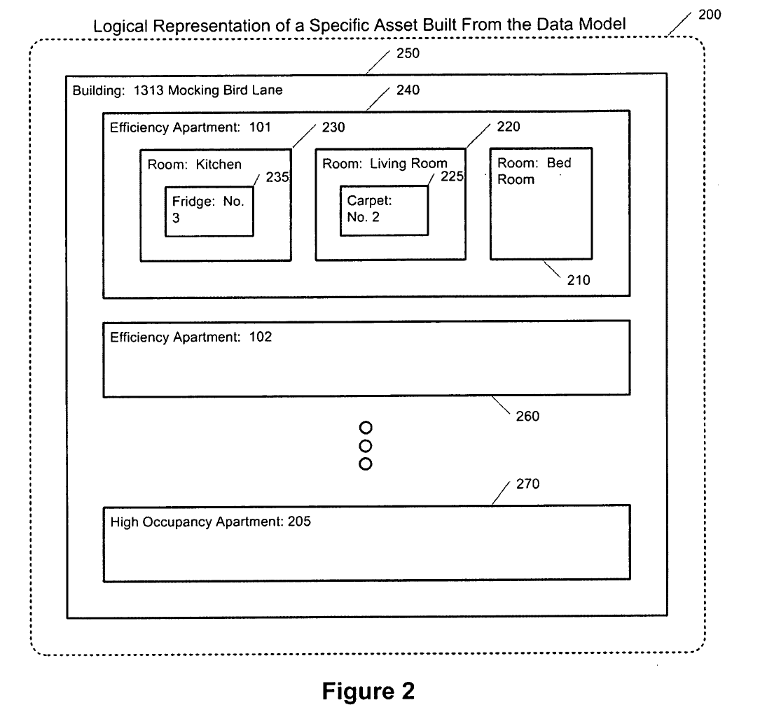

FIG. 2 depicts a possible logical view of an instantiation of a specific asset built from a data model. In the example shown in FIG. 2, the asset is a real world property located at a specific address.

Example asset 200 comprises building 250 located at 1313 Mocking Bird Lane where an inspection could occur. It is contemplated that an individual creates asset 200 from a data model created to describe the characteristics of building 250. Building 250 is created from a building target within the data model by filing in a data member field with the building's address, by assigning a unique identifier (a GUID for example), or other operations. Furthermore, building 250 comprises a plurality of target objects including created apartments 240, 260, or 270, where each apartment further comprises other objects. For example, apartment 240 represents an efficiency apartment identified by “unit number 101.” Apartment 240 comprises kitchen 230, living room 220, or bedroom 210. Each room can further comprise created objects including the refrigerator 230 or carpet 225. Further object instantiations are possible beyond those presented in the example.

Each object within asset 200 is instantiated from a target within a data model. Consequently, the objects carry all the attributes, conditions, or categories linked with the objects. For example, if the data model comprises a room target, the room target could also include a paint target to reference the walls of the room. Kitchen 230 comprises paint objects because kitchen 230 includes the room target. Furthermore, kitchen 230 comprises the attributes of the paint target which could include color which has conditions that could include faded, chipped, or other paint related condition values. In addition, kitchen 230 will comprise any categories associated with any of the characteristics linked with the room target, paint target, attributes, or conditions. As an example of categories, the room target could include a category called “electrical” to indicate the room should be inspected for electrical wiring. Living room 220 and bedroom 210 will also carry the electrical category. Consequently, when an asset survey is instantiated, the survey could be created by filtering all the objects within asset 200 based on the electrical category, which would automatically include all objects instantiated from the room target because the room target includes the electrical category.

It is contemplated that when each object within the asset, including the asset itself, is created is also assigned a unique identifier. In a preferred embodiment, the unique identifier comprises a GUID assigned during the process of insanitation. Unique identifiers aid in tracking how an asset or asset objects change in time.

When an individual creates an asset, it is contemplated that the asset will change in time.

For example, as asset 200 is used through time, carpet 225 which is a specific carpet, could be replaced by a second different carpet. Therefore, asset 200 could also be utilized as a method of tracking inventory. Furthermore, objects within asset 200 can also change in time. As inspection data is collected for asset 200, the data can be advantageously stored in a database where each object can be tracked as a function of time. For example, carpet 225 could have a “useful lifetime” attribute that decreases every year when an inspection is conducted or a “wear” attributed that indicates the wear and tear of carpet 225. The wear inspection data can then be employed to asses how tenants are treating objects within asset 200 or for preventive maintenance.

Asset 200 represents a logically nested representation of building 250; however, those ordinarily skilled in the art of data structures will appreciate alternative representations are possible. In a preferred embodiment, an instantiated asset can be represented from one or more views including hierarchical views, nested views similar to asset 200, category views, or other views preferred by individuals creating assets.

In yet another embodiment one or more software applications guide the asset creator through the process of creating an asset. It is contemplated that a software application provides the creator an user interface to input data for each object, including addresses, serial numbers, colors, names, or other asset object information.

In preferred embodiments, instantiated assets are stored in one or more files on a file system on a computer readable medium. In addition, it is contemplated that the objects within an asset comprise information that refers back to the characteristics stored in a data model. Contemplated information includes using each element's unique identifier to refer back to the data model housing the characteristics. It should be appreciated that one advantage of data models includes the ability for individuals to create multiple assets from a single data model. After an individual instantiates an asset from a data model, they can create asset surveys.

Asset Surveys

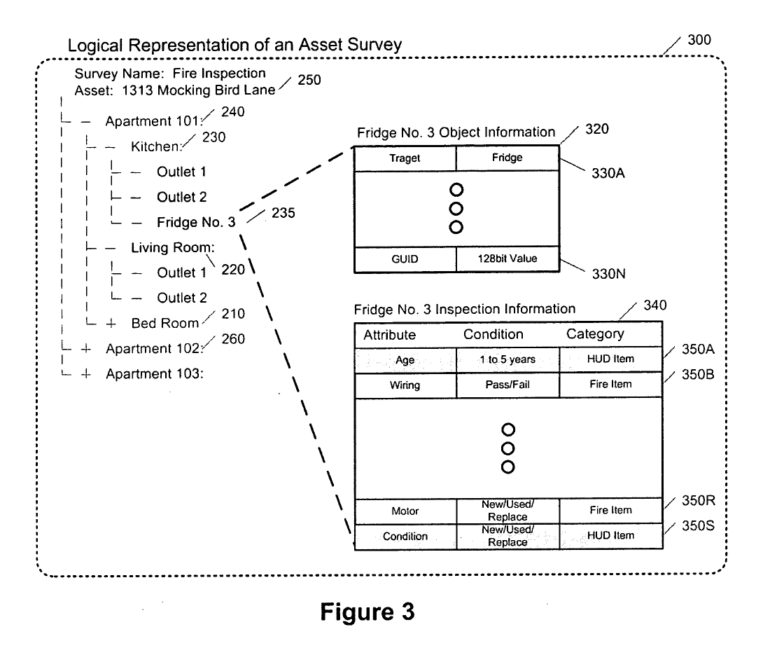

FIG. 3 presents a logical representation of an instantiated asset survey customized to an asset. In the example presented in FIG. 3, survey 300 has been created from asset 200. In the example, survey 300 represents a fire inspection. When survey 300 is created, it is contemplated survey 300 comprises a snapshot of asset 200. Asset 200 can change as time passes when the characteristics of its data model changes, when physical objects change, or when other changes in asset information occur; therefore, one snapshot of asset 200 could be different from another snapshot of asset 200 taken at a different time.

Asset survey 300 comprises object information for each object that is relevant to fire inspection survey 300 of asset 200. Example asset survey 300 includes information for building 250, apartments 240 and 260, rooms 230,220, and 210, and refrigerator 235. Each object comprises object information describing the specifics of the object as well as inspection information associated with the inspection points for object. For example, object information 320 comprises data 330A through 330N relating to the specific refrigerator 235 in asset 200. It is contemplated the object information was created during the insanitation of the asset. Object information 320 includes type of target, GUIDs, or other information to identify the object. Furthermore, in the example, inspection information 340 is associated with the object. Inspection information 340 comprises records 350A through 350S gathered from the data model. Inspection information 340 is advantageously employed to define inspection points or the inspection data to be collected.

In a preferred embodiment, survey 300 is created through the use of a software utility. When survey 300 is instantiated, the survey creator filters objects based on category information or manually selects asset objects or data model elements to be included in the survey. For example, in fire inspection survey 300, only objects that include a “fire item” category are included. Although inspection information 340 comprises other categories in records 350A and 350S, records 350B and 350R comprise the fire item categories and cause refrigerator 235 to be included in the survey. It is specifically contemplated that an asset survey comprises a set of filter parameters that can be applied to an asset to instantiate a survey. For example, a filter parameter includes filtering as a function of mathematic relations (i.e. <, >, or =), regular expressions, or other programmatic relationships.

Assets surveys are advantageously stored in a file within a file system on a computer readable medium. Furthermore, similar to assets, one should appreciate that multiple surveys can be advantageously created from a single asset. Contemplated asset surveys include move-in surveys, move-out surveys, safety inspections, insurance inspections, home inspections, or state mandated inspections. It is especially contemplated that state mandated inspections include those for HUD, fire inspections, or those associated with affordable housing.

Once an asset survey has been instantiated, preferably, an order is created for an inspection. An order represents a subset of an asset survey that can be stored on a portable inspection device. It is contemplated an order comprises one or more files including the necessary inspections points where an inspector should collect inspection data. Furthermore, it is contemplated that an order comprises inspection points for one or more asset surveys to allow inspection data for different reasons to be collected at the same time. In a preferred embodiment an order comprises an XML file interpreted by a portable inspection device; however, other data files formats are also contemplated.

State Mandated Surveys

In an especially preferred embodiment, asset surveys comprise state mandated surveys. State mandated surveys are inspections required by municipal, country, state, region, federal, or world organizations to ensure assets meet specified criteria. It is contemplated that residential or commercial assets could require inspections mandated by the Real Estate Assessment Center (REAC) managed by HUD. If an affordable housing complex fails a HUD REAC inspection, property owners could loose HUD funding which would cause tenants to loose access to the affordable housing they require. Therefore, the inventive subject matter advantageously provides property owners a method to ensure inspections are preformed properly. An especially preferred HUD REAC inspection includes those that have information from the Uniform Physical Condition Standards (UPCS).

Another contemplated mandated inspection could include those stemming from the Americans with Disabilities Act (ADA) which mandates disabled persons have access to public places or businesses. An asset survey created according the ADA Accessibilities Guidelines (AD)AAG) ensures an asset fulfills the criteria for accessibility.

Although REAC or ADA inspections are contemplated for residential or commercial real estate, it is also contemplated that other state mandated inspections fall within the scope of the inventive subject matter including those yet to be mandated. Furthermore, assets that are not real estate assets are also contemplated to have state mandated inspections. For example, in the transportation industry, trucks, busses, or airplanes have state mandated inspections including those for safety.

Portable Inspection Device

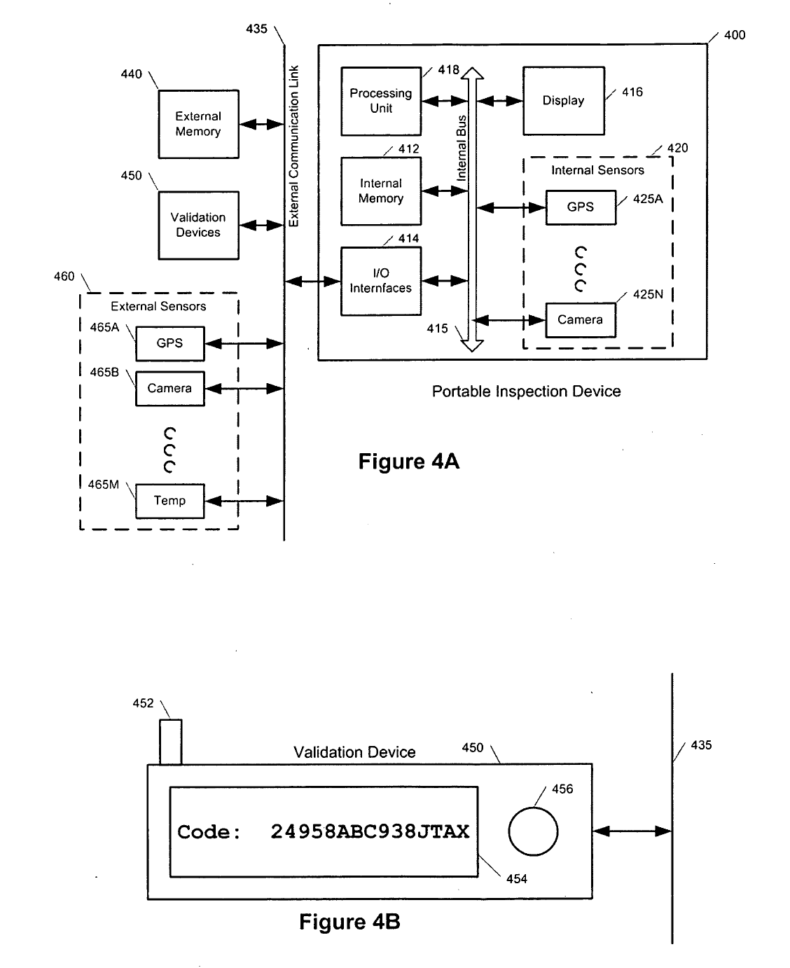

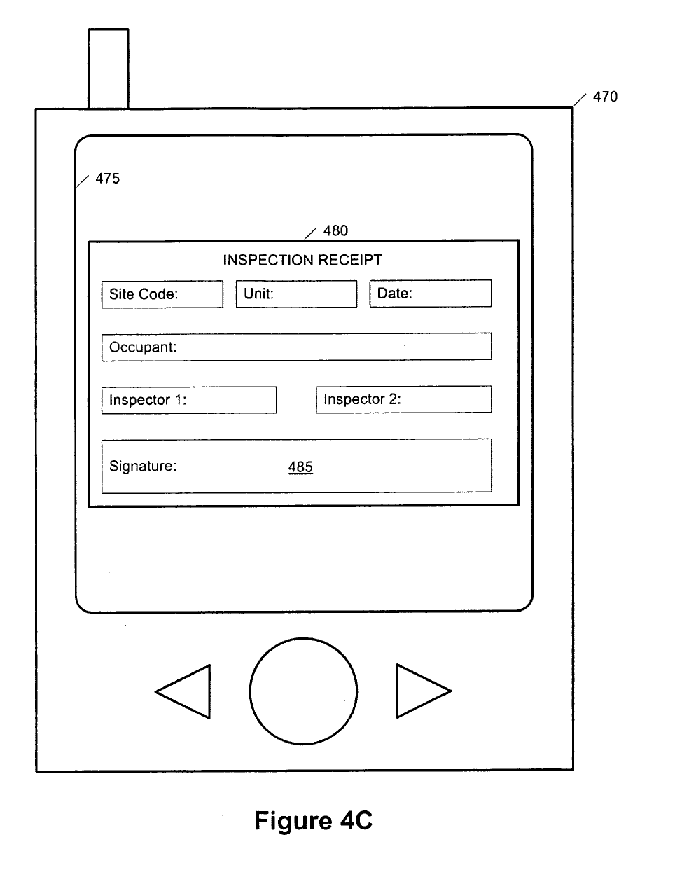

FIG. 4A presents a possible schematic for a portable inspection device. Inspection device 400 comprises a plurality of elements that communicate over internal bus 415. Processing unit 418 executes instructions obtained from internal memory 412. It is contemplated that inspection device 400 displays infonrmation to an inspector through display 416 and obtains inspection data or validation information through optional internal sensors 420. Internal sensors 420 include sensors 425A through 425N. In a preferred embodiment, internal sensors 420 comprise a GPS sensor, camera, microphone, thermometer, or other sensors useful to collect inspection data. Inspection device 400 could also communication to optional external elements through I/O interfaces 414 on external communication link 435. Examples of external communications link 435 include USB, Firewire, Bluetooth, RS232, IrDA, 802.11, Ethernet, or other wired or wireless links. Examples of optional external elements include external memory 440, validation device 450, or additional external sensors 460. Contemplated sensors 465A through 465M include a GPS device, camera, radon detectors, thermometers, infrared thermometers, humidity detectors, or other sensors that can capture inspection data or validation information.

Sensors 420 or 460 also include devices that inspectors use to take measurements or record data. Additional sensors include devices that measure height, width, depth, distance, lengths, or other physical dimensions associated with the asset or with the objects within the asset. Physical dimensions become important for surveys where objects or people have specific physical limitations as in ADA mandated inspections. Other contemplated sensors include penetrating sensors that are able to take measurements through various forms of material. Examples of penetrating sensors include those that employ infrared techniques, ultrasound, acoustic, X-ray, vibration, or other capabilities that penetrate materials. Penetrating sensors can be adventurously used for detecting broken pipes, incomplete welds, structural defects, or other items that are prescribed by an asset survey.

Contemplated inspection devices include cell phones, PDAs, portable computers, tablet PCs, or devices specifically built for collecting inspection data. In a preferred embodiment, inspection device 400 represents a PDA running Windows® CE with an inspection application stored in memory associated with the inspection device including any combination of internal memory 412 or external memory 440. In addition, an order built from an asset survey is stored in the memory associated with inspection device 400, including memories 440 or 412. Examples of external memories include flash media (memory stick, SD cards, compact flash, MMC, or other flash), magnetic media, USB thumb drives, disk drives, or a memory located remotely from the inspection device 400.

In a preferred embodiment an application stored on memories 440 or 412 executes on processing unit 418. The application interprets the order file from the survey and guides the inspector through the inspection process by presenting the inspector with an overview of the locations within the asset to be visited. In a preferred embodiment, the application comprises a browser that interprets the XML order file. At each inspection point, the application accepts inspection data supplied by the inspector through the sensors 420 or 460, through the I/O interfaces 414, or through display 416. The application stores the inspection data along with any associated validation information in the memory associated with inspection device 400, memory 440 or 412, for example.

Inspection data represents the data collected at each inspection point. Contemplated inspection data includes video data, image data, audio data, captured data, contamination data, infestation data, environment data, opinion data, or other types of data requested by the asset survey or the survey order. In a preferred embodiment, video data or image data is captured through cameras 425N or 465B. Other captured data includes bar code information, RFID tag information, or other data capture through sensors 420 or 460. Contamination data comprises information resulting from a measurement of non-living material at an inspection point. Example contamination data includes asbestos information, radon gas, carbon monoxide measurements, or others. Infestation data comprises information resulting from an observation of living material. Examples of infestation data include evidence of termites, fungus, mold, rats, or other living material. Opinion data reflects an inspector's opinion about an inspection point. For example, if the inspection point comprises a pass/fail attribute, the inspector assess the inspection point, then determines if the condition associated with the attribute should be pass or fail by selecting the appropriate value presented by the application. Environment data includes temperature, humidity, or other environmentally measured data.

Validation information comprises additional data associated with the inspection data that is used to establish the inspection data or the whole inspection is a valid inspection. Contemplated validation information comes from GPS 425A or 465A information where time or location information is recorded with the inspection data. Alternative validation information includes time or location information obtained from cell phones, mesh networks that support triangulation, wireless access points, or other signals that result in a time or location information. Location information could include absolute locations on a world coordinate system, relative locations to one or more marks, two dimensional, or three dimensional coordinates.

In yet another embodiment, validation information includes data collected at inspection points through internal sensors 420 or 460. As an inspector visits inspection points, it is contemplated that the inspector could collect Radio Frequency Identification (RFID) information or bar code information for objects associated with the asset. For example, a carpet, refrigerator, table, chair, or other objects could comprise one or more RFID tags or bar codes that are read by sensors 420 or 460 to properly ID the objects or the inspection point. RFID tags or bar codes are useful when confirming an object has not changed as time passes or useful to ensure inspectors visit each prescribed inspection point. In this sense, RFID tags or bar codes can also serve as inspection data.

Validation information can extend beyond time or location information. One skilled in the art of validating information will appreciate alternative validation information exists all of which within the scope of the inventive subject matter. For example, validation information could include information supplied by a third party, a secret, comparison information, certificates, or other information that substantially fulfills the role of validating an inspection. Third party information could include inspection codes correlated to inspections or inspection data. Additionally, secrets could be used to encrypt inspection data to prevent the data from being falsified. Contemplated secrets include secrets that have a valid lifetime wherein an inspection using a secret is only valid if completed within the lifetime of the secret. Certificates include those provided by companies similar to VeriSign®.

Validation Device

FIG. 4B illustrates an alternative embodiment where validation information could be obtained from contemplated validation device 450. Validation device 450 is contemplated to comprise an external interface 452 used to gather data or signals, display 454, or control interface 456. It is contemplated that validation device 450 is under the control of a trusted third party. Validation device 450 could advantageously be employed in a similar manner as a photograph of a person holding a newspaper to validate when the photograph was taken. In the same manner, as an inspector takes image data, validation device 450 could be included in the photo of the inspection point so the display 454 is visible. It is contemplated that display 454 shows a “validation code” that is synchronized to a similar device with the trusted third party. Validation device 450 is also contemplated to communicate validation information with inspection device 400 over communications link 435. Furthermore, validation device 450 could advantageously employ options external sensors 460. All contemplated validation device existing now or yet to be conceived fall within the scope of the inventive subject matter.

Inspection Receipt

FIG. 4C illustrated yet another embodiment of how validation information can be obtained. The example of FIG. 4C shows PDA 470 as an inspection device. It is contemplated that as an inspector conducts inspections, the inspector can collect signatures of tenants in a residential property or a commercial property. Paper inspection receipt 480 is overlaid on display 475. As receipt 480 is filled out, PDA 470 advantageously captures the information which can be considered validation information. Receipt 480 information is stored in a memory associated with PDA 470. It is especially contemplated, that receipt 480 comprises signature block 485 which can be used at a future date. If a tenant files a claim against a property owner or insurance company, the defendants can produce a paper copy or electronic copy of receipt 480 with the plaintiff's signature indicating an inspection was performed, was valid, or other relevant indications. Contemplated receipts include those that produce multiple copies that fit display 470 in different orientations, which are perforated to provide the signer a copy, or all other forms of receipts. One should appreciate that receipt 480 is not limited to a PDA, but any type of data capture device. Other contemplated forms of validation information from individuals include biometric, retina scans, finger prints, or other personal information captured through sensors 420 or 460.

Conducting an Inspection

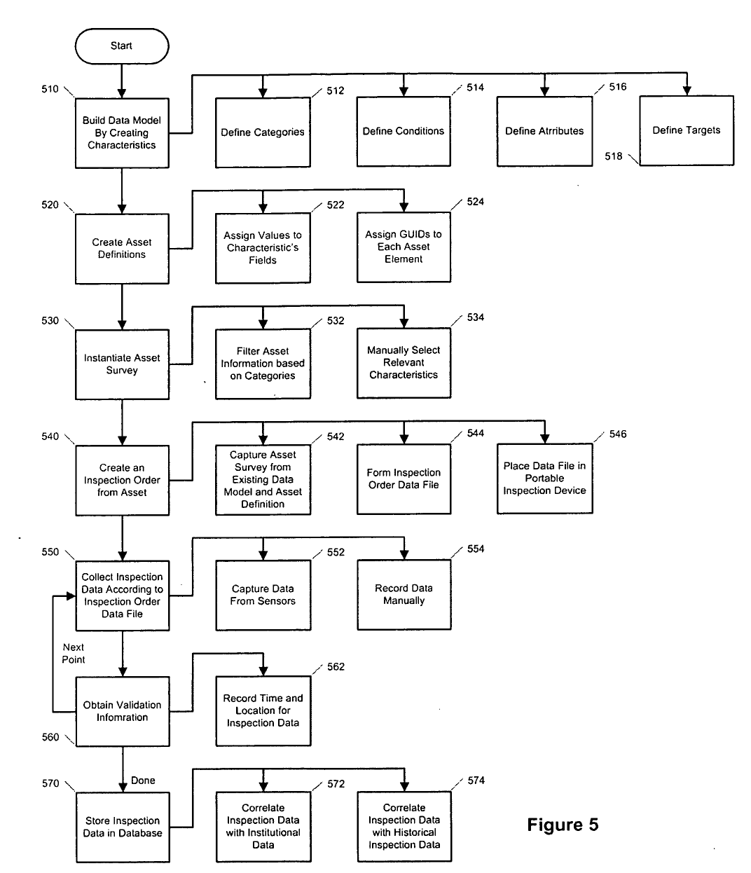

FIG. 5 represents a series of possible steps employed to conduct an inspection.

Building a Data Model.

At step 510 a data model is created by defining a plurality of characteristics that could be associated with an asset. In a preferred embodiment a software utility guides the creator of the data model through the process of creating the data model. The data model creator establishes one or more categories at step 512 that have relevance to the data model. The creator also defines one or more conditions at step 514 that are expected to be encountered during an inspection. One or more attributes are defined at step 516, and finally one or more targets are defined at step 518. Steps 512 through 518 can occur in any order and are contemplated to take place in an iterative approach until a satisfactory data model has been established. The iterative approach can be considered similar to writing an application program in a computer language where parts of the program are created, tested, or debugged repeatedly until ready for use. The final result of the creation process is a data model stored in a computer readable memory. Examples of acceptable computer readable memories include RAM, flash (memory sticks, flash cards, MMC, etc. . . . ) hard disk drive, CD, DVDs, or other computer memories. In a preferred embodiment, an individual creates a real estate data model for use in real estate inspections.

Creating an Asset

At step 520, once the data model has been suitably established, an asset is can be created. The characteristics within the data model have fields that can be filled out during the process of creating an asset. At step 522, each relevant field for each object within the asset is defined. The fields aid in the definition of a specific real-world object. For example, a building has an address filed. At step 524, it is contemplated that each object in the asset or the asset itself is assigned a GUID. The GUID aids tracking the characteristics, inspection data, or other information associated with an object through the history of the object. It is contemplated that steps 522 and 524 are preformed through the software utility in any order.

Instantiating an Asset Survey

At step 530, an asset survey is instantiated from the asset and is customized to the asset, especially a real estate asset. The characteristics of an asset are filtered automatically or through manual operations. At step 532, it is contemplated that the creator of the asset survey could instantiate an asset survey through filtering asset information based on categories. Furthermore, at step 534 an individual could manually select preferred items to be included or excluded within the survey. Steps 532 and 534 are contemplated to occur iteratively in no particular order until the asset survey is considered complete.

Creating an Asset Survey Order

An order for an inspection is created from the asset or the asset survey at step 540. The order comprises information gathered regarding the asset survey, asset, or the data model at step 542. Then, at step 544, and order file is created that can be deployed into a memory associated with a portable inspection device at step 546. The order file is interpreted by an application comprising software, firmware, or hardware, on the inspection device to guide an inspector through the inspection process. In a preferred embodiment a survey order is uniquely identified. Because an order has a unique ID, a GUID for example, multiple inspectors could conduct the same inspection at different times. The results of the duplicate inspection process can then be compared to each other as a way to validate the inspection.

Inspecting

At step 550 an inspector uses a portable inspection device along with any associated sensors to collect inspection data at inspection points defined in the order file. At step 552, the inspector captures data that could include image data, video data, contamination data, infestation data, environment data, or other sensor data. At step 554, the inspector collects non-sensor data including data manually entered into the portable inspection device. In a preferred embodiment, the inspector is able to visit inspection points in any order. Furthermore an inspector can collect inspection data over an extended period of time if an order can not be completed in a single visit. It is also contemplated multiple inspectors could collect inspection data associated with the same order in parallel or at different times using the same or different inspection devices.

Obtaining Validation Information

At step 560 an inspector obtains validation information associated with inspection data, preferably recording time or location data at step 562. Validation information can be collected automatically through the inspection device or manually through the inspector's actions. Contemplated automated recording of validation information includes tracking a near continuous series of time or location data points or near continuous video stream as the inspector conducts the inspection. In a preferred embodiment, the validation information is recorded at the same time inspection data is collected where the validation information is coupled to the inspection data. Contemplated manual recording of validation information includes taking images that include external information possibly including information from validation device 450.

Validation information can be collected on a per inspection point basis or on a per inspection basis. If the validation information is collected on a per inspection point basis, then once the validation information is obtained, the next inspection point is visited at step 550.

Data Mining

After an inspection is complete and the inspection data or possibly the validation information is recorded within the memory associated with the inspection device, the data is stored in a database at step 570. In a preferred embodiment, the database houses inspection data associated with multiple assets or objects within the assets for multiple inspections. This allows data associated with an asset to be mined for information. For example, the historical asset data can be advantageously correlated with institutional data at step 572. Institutional data represents data associated with institutions beyond the asset including state agency information, tenant files, HUD information, construction standards, or other information of value to institutions. Comparing historical asset data with tenant records allows for establishing trends of individuals that are considerate of the asset or that are inconsiderate of the assets. Furthermore, at step 574 the historical data itself can be mined to aid in property management. For example, historical asset data can determine when appliances should be replaced or be upgraded, when a new fire inspection should be done, or for other management reasons. Data mining aides in reducing costs associated with property management, insurance processing, or helping those in need of affordable housing who have a track record of being good tenants.

Validation Methods

One skilled in data acquisition will appreciate the many possible methods for validating inspection information. The following examples are included to illustrate the broad application of the inventive subject matter, without implied limitation to the examples.

Securing Inspection Data

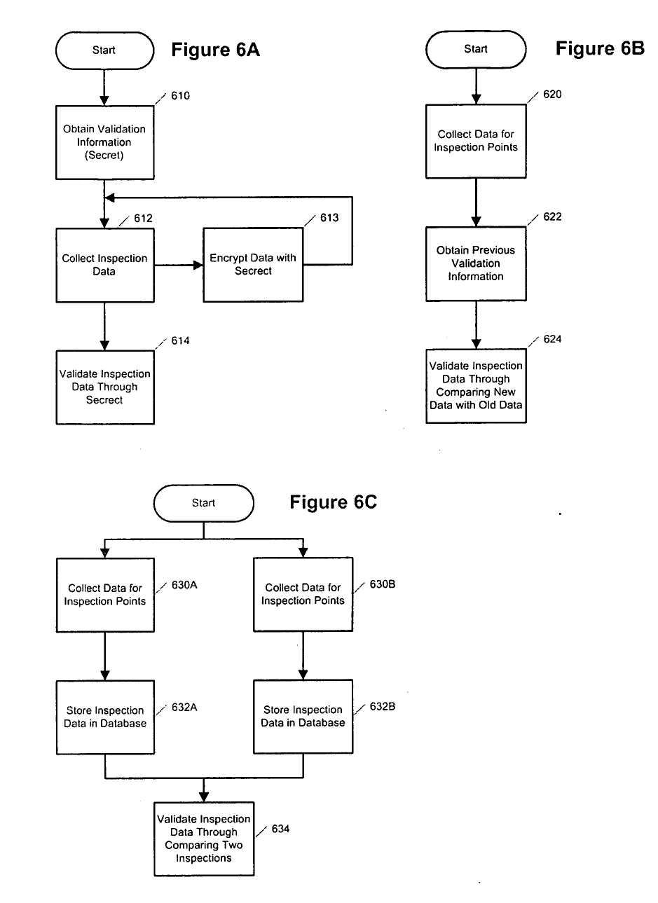

FIG. 6A illustrates obtaining validation information in the form of a secret. At step 610 a secret is obtained for use in encrypting inspection data. Examples of secrets include those commonly exchanged through public key infrastructure (PKI). It is contemplated that secrets are used to secure inspection data through any standard algorithm including AES, DES, 3DES, ECC, those supported by FIPS 140-2 maintained by NIST, or other well defined algorithms.

At step 612, inspection data or other validation information is collected then encrypted at step 613. Once the data is encrypted, the process repeats as the inspector continues the inspection process. It is also possible that a secret could be obtained for every inspection point; however, this would require a large number of communications during the inspection process which would result in a slower inspection process as an inspector waits for a valid secret to be obtained.

Once the inspection data has been collected, the inspection data can be validated at step 614 by decrypting the inspection data through the use of the secret. In a preferred embodiment, a key is obtained for a survey order before the inspection begins. In an especially preferred embodiment, the secret is obtained through a trusted third party. In such an embodiment, it is contemplated the secret could comprise a lifetime for which the secret is valid. Inspection data or validation information can be considered valid within the lifetime of the secret if the inspection is completed and submitted to the third party within the lifetime. The third party would control the lifetime of the secret.

Validation through Comparison

FIG. 6B illustrates a validation process through the use of comparison data. At step 620, inspection data or validation information is collected at inspection points as determined from a survey order. Once the data and information has been collected, previous validation information or inspection data for the same asset is obtained from a previous survey at step 622. At step 624, the inspection data is validated through comparing the current validation information with the previous validation information. Again, step 624 could advantageously be performed by a trusted third party.

Inspection in Parallel

In yet another embodiment, FIG. 6C illustrates how multiple inspections associated with a single survey order can be conducted in parallel. At steps 630A and 630B, inspection data or validation information is collected at inspections points associated with the survey order. It is contemplate that each element of data collected comprises a GUID wherein the GUID provides a method for distinguishing between the two data sets. At step 632A and 632B, the data sets are stored in a database. Then at step 634 the inspection datasets are compared to validate the information. Step 634 could be performed manually or, preferably automatically, to determine how closely the information matches. For example, each inspection point's location information obtained from triangulation data is unlikely to vary widely from one inspection to another. Furthermore, the parallel inspections can be conducted at different times to ensure two inspectors do not interfere with each other.

Additional Validation Considerations

The previous three examples illustrate varied approaches to validating an inspection though obtaining validation information. Additional considerations are included in the preferred embodiment. Specifically contemplated validation information includes obtaining information from a person other than the inspector at the inspection site during the time of the inspection. The person could include the property owner, a trusted third party, a tenant, a safety inspector, or other individual. Preferred personal information includes obtaining a signature from the individual. Especially preferred signatures are those captured on a form that creates a suitable copy of the signature and where the signature is captured electronically, on PDA 470 for example through receipt 480. For example, a paper receipt could be placed as an overlay on the portable inspection device. If the inspection device is a PDA, the paper receipt could overlay the display of the PDA. As the individual signs the paper receipt, the PDA captures their signature electronically. The inspector provides the individual a copy of the receipt, and a paper original can be stored for future use, possibly during legal action.

Other contemplated validation information includes recording voice data, finger prints, bio-metric data, photographs of individuals, or other data that links an inspection to an individual.

Advantages

Numerous advantages are gained through the use of the presented inventive subject matter. Data models and assets provide a central, cohesive strategy for creating multiple types of inspections. Rather than keeping duplicate information regarding the many possible inspections that could be imposed on an asset, a survey can be generated without building up the asset information repeatedly for different reasons, agencies, or purposes. Furthermore, a survey can be generated over and over again even as an asset changes through the passage of time. In a similar vein, multiple inspections can be combined into a single survey order. By commingling inspections, an inspection need only be visited once, rather than multiple times.

Validation information taken along with inspection data or associated with the inspection provides proof to property owners, to insurance companies, to the state or to other individuals the inspection was conducted properly. The proof helps reduce costs of litigations against property owners and helps insurance companies reduce their threshold for settling out of court. For example, if a tenant is required to provide a signature that indicates the inspection data is valid, they are less likely to make a claim against the property owner or the insurance company for the condition of the housing in which they reside.

Data mining of historical asset information data provides valuable information to the property owner or to institutions. Property owners can mine the historical data to track objects within the asset to know when upgrades, repairs, or replacements are necessary. Institutions including the state can mine the data to correlate the behavior of their charges. For example, the state can track how tenants impact affordable housing.

Markets

Although this document presents the inventive subject matter from a real estate perspective, it is contemplated that other markets would benefit from the presented concepts. Contemplated markets where inspections are conducted regularly include the medical industry, banking industry, automotive, industrial, educational, farming, or others.

Additionally, it is contemplated that other markets could spawn from the application of the inventive subject matter. An industry could be established to create relevant data models for various markets where individuals purchase the data models for customization and for creating asset definitions. Furthermore, such an industry would benefit from the development and sales of software or hardware designed to couple closely with the data models, validation devices for example. Establishment of trusted third parties could result in a business model where the third parties validate inspection information for insurance companies. Businesses established through the used of data models, assets, asset surveys, or validation are considered to fall within the scope of the inventive subject matter.

Hardware

In yet another aspect, hardware or hardware devices could be built to facilitate the use of the inventive subject matter. For example, validation devices could be developed or deployed in the field to ensure inspections are valid. Furthermore, hardware devices could include those that capture inspection data or validation data without inspector interaction. Contemplated hardware devices include devices that remain with an assets while capturing data or storing data for later retrieval or other automated data capturing devices. Therefore, the inventive subject matter includes apparatus or methods of developing or using asset inspection or validation devices.

Software

In still another aspect, it is contemplated that one could write software that would configure, simulate, or manage data models, assets, asset survey, validation information, and their associated infrastructure. From that perspective the inventive subject matter includes methods of writing such software, recording the software on a machine readable form, licensing, selling, distributing, installing, or operating such software on suitable hardware. Moreover, the software per se is deemed to fall within the scope of the inventive subject matter.

Thus, specific compositions and methods of inspections have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A method of conducting an inspection, comprising:
(a) building a data model representing characteristics of a real estate asset in a first computer readable memory;
(b) using the data model to instantiate an asset survey customized to the real estate asset, storing at least a portion of the data model in a second computer readable memory associated with a portable inspection device;
(c) collecting inspection data responsive to the survey, and storing the data in the second computer readable memory; and
(d) obtaining validation information associated with the inspection data and storing the validation information in the second computer readable memory.

2. The method of claim 1, wherein the validation information comprise time and location information.

3. The method of claim 2, wherein at least one of the time and location information comprises information from at least one of the following a GPS, a cell phone, an access point, and a network connection.

4. The method of claim 1, wherein the step of obtaining validation information comprises obtaining a secret associated with the asset survey.

5. The method of claim 4, wherein the secret is associated with inspection data.

6. The method of claim 4, where in the secret has a life time.

7. The method of claim 1, wherein the validation information includes previous inspection data from a previous asset survey.

8. The method of claim 1, wherein the step of obtaining validation information includes recording validation information from a validation device.

9. The method of claim 8, wherein the validation device is controlled by a trusted third party.

10. The method of claim 1, further comprising validating the asset survey through a trusted party.

11. The method of claim 1, wherein the step of obtaining validation information further comprises obtaining a signature of a person other than an inspector.

12. The method of claim 11, further comprises providing the person with a receipt of the signature.

13. The method of claim 12, wherein the receipt comprises an overlay for the portable inspection device.

14. The method of claim 1, wherein asset survey comprises a state mandated survey.

15. The method of claim 1, wherein the inspection data comprises at least one of the following video data, audio data, contamination data, infestation data, image data, environment data, and opinion data.

16. The method of claim 1, wherein the inspection comprises at least one of a residential inspection and a commercial inspection.

17. The method of claim 1, further comprising storing the inspection data in a database comprising historical asset inspection data.

18. The method of claim 17, further comprising correlating the historic asset inspection data with institutional data.
